(19) United States
(12) Patent Application Publication
(10) Pub. No.: US 2020/0020335 A1
(43) Pub. Date: Jan. 16, 2020

(54) METHOD FOR PROVIDING VUI PARTICULAR RESPONSE AND APPLICATION THEREOF TO INTELLIGENT SOUND BOX

(71) Applicant: Tymphany Acoustic Technology (Huizhou) Co., Ltd., Huizhou City (CN)

(72) Inventor: Xudong LIU, Huizhou City (CN)

(21) Appl. No.: 16/505,088

(22) Filed: Jul. 8, 2019

(30) Foreign Application Priority Data
Jul. 11, 2018 (CN) 201810756067.6

(51) Int. Cl. G10L 15/22; G10L 15/07; G10L 25/78; G06F 16/9032; G10L 17/04; G10L 17/26

(52) U.S. Cl. CPC G10L 15/22; G10L 15/075; G10L 25/78; G10L 2015/223; G10L 17/04; G10L 17/26; G10L 2015/225; G06F 16/90332

(57) ABSTRACT

A method for providing a voice user interface (VUI) particular response includes receiving a voice instruction; accessing a voice archive in a voice database and identifying whether the voice instruction is abnormal, generating a search instruction when deteimining that the voice instruction is abnormal, and transmitting both the voice instruction and the search instruction out; searching for a corresponding feedback based on the voice instruction and the search instruction, and generating first feedback information and second feedback information; and outputting the first feedback information and the second feedback information. Abnormality of physiological information is determined through voice sample collection and continuous interaction, and a feedback is provided, to resolve a problem of running termination due to difficulty of voice identification and provide desirable user interface experience.

### CROSS REFERENCE TO RELATED APPLICATIONS

This application claims priority under 35 U.S.C. § 119 to Chinese Patent Application No. CN 201810756067.6, which was filed on Jul. 11, 2018, and which is herein incorporated by reference.

### BACKGROUND

### Technical Field

The present invention relates to the field of voice input and, in particular, to a method for providing a voice user interface (VUI) response and an application thereof to an intelligent sound box.

### Related Art

In recent years, with the technical development of wireless networks, intelligent mobile phones, cloud networks, and Internet of Things, various control manners such as graphical user interfaces (GUIs) or voice control continuously emerge to satisfy requirements of users.

The GUI is a computer operation user interface for displaying by using graphics. At present, there is a voice user interview (VUI) allowing a user to execute instructions in a manner of voice input. In short, these interfaces are all interfaces for serving users and providing better direct interaction for the users.

The VUI mainly receives voice, identifies the voice (converting the voice into text), and executes a corresponding instruction based on content of the text. That is, an existing VUI performs only a function of “voice assistant”.

### SUMMARY

When receiving speech, a VUI not only can identify a language and text, but also can receive “voice” unrelated to the speech (language). A combination of the voice (an audio structure) and the language (content semantics) represents a physiological (or mental) state such as joy, anger, sadness, happiness, illness, and health when a user speaks.

Therefore, this application provides a method for providing a VUI particular response, including a voice input step, a physiological information determining step, a search step, and a feedback information output step. The voice input step includes receiving a voice instruction. The physiological information determining step includes identifying whether the voice instruction is abnormal, generating a search instruction when determining that the voice instruction is abnormal, and transmitting the voice instruction and the search instruction out. The search step includes searching for a corresponding feedback based on the voice instruction and the search instruction, and respectively generating first feedback information and second feedback information. The feedback information output step includes outputting the first feedback information and the second feedback information.

In some embodiments, the method for providing a VUI particular response further includes a storage step of storing the voice instruction in a voice database.

Further, in some embodiments, the method for providing a VUI particular response further includes an identification step of adding a label to the voice instruction when determining that the voice instruction is abnormal. Then the storage step is performed, which includes storing, in the voice database, the voice instruction added with the label. Further, in some embodiments, the label of the voice instruction stored in the voice database may be further modified based on a subsequent voice instruction.

In some embodiments, the physiological information determining step includes comparing a reference waveform of the voice instruction with that of a voice archive to determine whether the voice instruction is abnormal.

An intelligent sound box is also provided herein. The intelligent sound box includes a voice instruction input unit, a voice database, a physiological information determining unit, a data processing unit, an information transmission and receiving unit, and a feedback information output module.

The voice instruction input unit is configured to receive a voice instruction and transmit the voice instruction out. The voice database is configured to receive and store the voice instruction, is electrically connected to the voice instruction input unit, and further stores a plurality of voice files. The physiological information determining unit is configured to: receive the voice instruction, identify whether the voice instruction is abnormal, generate a search instruction when the physiological information determining unit determines that the voice instruction is abnormal, and transmit the search instruction and the voice instruction out. The data processing unit is electrically connected to the physiological information determining unit, and configured to: receive the voice instruction and the search instruction, encode the voice instruction and the search instruction, and transmit the voice instruction and the search instruction out. The information transmission and receiving unit is electrically connected to the data processing unit, and configured to: transmit the voice instruction and the search instruction that are encoded, receive first feedback information and second feedback information that correspond to the voice instruction and the search instruction, and transmit the first feedback information and the second feedback information to the data processing unit for decoding. The feedback information output module is electrically connected to the data processing unit, and configured to: receive the first feedback information and the second feedback information that are decoded by the data processing unit, and output the first feedback information and the second feedback information.

In some embodiments, the physiological information determining unit is configured to determine a waveform and compare a waveform of the voice instruction with that of a voice archive to determine whether the voice instruction is abnormal.

In some embodiments, the information transmission and receiving unit is wirelessly connected to a cloud server, and the first feedback information and the second feedback information are correspondingly generated by the cloud server respectively based on the voice instruction and the search instruction that are encoded.

In some embodiments, the feedback information output module includes a voice output unit, configured to covert the first feedback information and the second feedback information into voice information for playing. Further, in some embodiments, the feedback information output module further includes a display unit, configured to convert the first feedback information and the second feedback information into text information or image information for displaying.

Based on this, voice samples are collected, and the intelligent sound box determines, when the voice instruction is input, a deviation value of voice of a user generating the voice instruction, to determine whether the user is physiologically abnormal and perform a subsequent determining and feedback mechanism, so that a conventional problem of identification difficulty is resolved, and the user can make a more real-time feedback or suggestion, thereby achieving better user interface experience.

### BRIEF DESCRIPTION OF THE DRAWINGS

FIG. 1 is a schematic block diagram of an intelligent sound box when a user is in a physiologically abnormal state;

FIG. 2 is a schematic block diagram of an intelligent sound box when a user is in a physiologically normal state; and

FIG. 3 is a flowchart of a method for providing a VUI particular response.

### DETAILED DESCRIPTION

Preferred implementations of the present invention are described below with reference to accompanying drawings. A person skilled in the art should understand that these implementations are merely intended to explain the technical principle of the present invention instead of limiting the protection scope of the present invention.

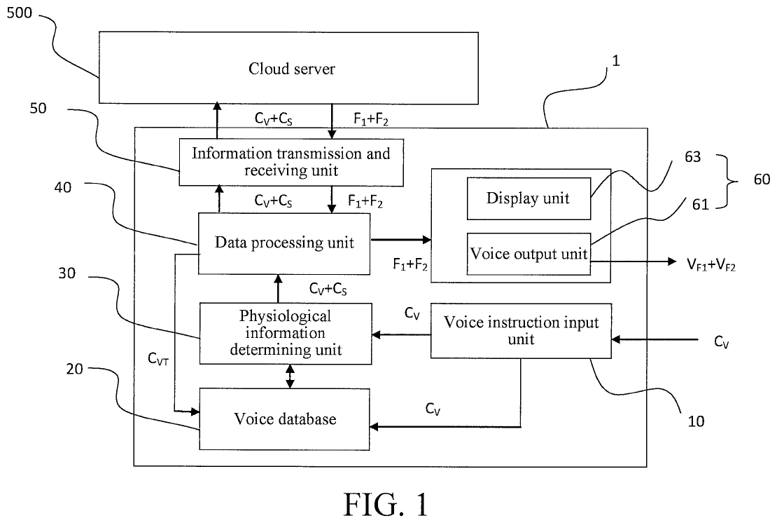

FIG. 1 is a schematic block diagram of an intelligent sound box in an abnormal state. As shown in FIG. 1, the intelligent sound box 1 includes a voice instruction input unit 10, a voice database 20, a physiological information determining unit 30, a data processing unit 40, an information transmission and receiving unit 50, and a feedback information output module 60.

The voice instruction input unit (for example, a microphone) 10 receives a voice instruction C_{V}. The voice database 20 is electrically connected to the voice instruction input unit 10. The voice database 20 stores the received voice instruction C_{V}. The voice database 20 further stores a plurality of voice files.

In more detail, the voice database 20 may store a plurality of voice files pre-recorded by a user. These voice files include a voice file recorded by the user in a normal state (for example, in a healthy state), and also includes a voice file recorded by the user in an abnormal state (for example, in an ill state). The recorded voice files are used for the determination in the following steps. Further, a voice instruction C_{V} generated by the user may be stored as a voice file. The physiological information determining unit 30 is electrically connected to the voice instruction input unit 10, receives the voice instruction C_{V}, and accesses the voice file to identify whether the voice instruction C_{V} is abnormal. The physiological information determining unit 30 generates a search instruction C_{S} when determining that the voice instruction C_{V} is abnormal and transmits the search instruction C_{S} and the voice instruction C_{V} out.

The data processing unit 40 is electrically connected to the physiological information determining unit 30, receives the voice instruction C_{V} and the search instruction C_{S}, encodes the voice instruction C_{V} and the search instruction C_{S}, and transmits the voice instruction C_{V} and the search instruction C_{S} out. The information transmission and receiving unit 50 is electrically connected to the data processing unit 40, and transmits the encoded voice instruction C_{V} and the encoded search instruction C_{S} to, for example, a cloud server 500. Next, the information transmission and receiving unit 50 receives first feedback information F₁ and second feedback information F₂ that are generated by the cloud server 500 and that correspond to the voice instruction C_{V} and the search instruction C_{S}, and transmits the first feedback information F₁ and the second feedback information F₂ to the data processing unit 40 for decoding. The feedback information output module 60 is electrically connected to the data processing unit 40, receives the first feedback information F₁ and the second feedback information F₂ that are decoded by the data processing unit 40, and outputs the first feedback information F₁ and the second feedback information F₂. The encoding performed by the data processing unit 40 herein may be compressing the voice instruction C_{V} such as a .wmv file into an .mp3 file, converting the voice instruction C_{V} into a .flac file in a lossless format, or converting the voice instruction C_{V} into a text file in a .txt format, to help the cloud server 500 or a computer to interpret. The foregoing is merely an example and the present invention is not limited thereto. Further, a format that can be interpreted by the feedback information output module 60 may be achieved through decoding in an inverse manner.

The foregoing implementation is merely an example and the present invention is not limited thereto. For example, the first feedback information F₁ and the second feedback information F₂ do not necessarily need to be generated through transmission to the cloud server 500, and this technology may also be performed by using a computing module installed in the intelligent sound box 1.

An example is used herein for detailed description. The physiological information determining unit 30 may be a waveform determining apparatus or the like. The physiological information determining unit 30 may access the plurality of voice files in the voice database 20 to obtain a reference waveform through. The reference waveform is used to compare and determine whether the voice instruction C_{V} is abnormal, so as to determine whether the user is physiologically abnormal. For example, when the user catches a cold, the vocal cords and a peripheral organ are swelling, causing a waveform change during vocal cord vibration. Therefore, a reference waveform of a voice instruction C_{V} generated when the user catches a cold is different from the reference waveform previously obtained through collage on the voice files when the user does not catch a cold. In addition, whether the voice instruction C_{V} is abnormal may be determined based on a deviation bottleneck value of the difference. For example, if the waveform deviation value of the difference exceeds 40%, the physiological information determining unit 30 determines that the voice instruction C_{V} is abnormal. The foregoing is merely an example, and the present invention is not limited thereto.

The search instruction C_{S} may generate an information instruction for searching for, such as the weather a few days ago, the temperature, and a hospital location nearby, based on a change of voice. However, the foregoing is merely an example, and the present invention is not limited thereto. For example, whether users generating voice instructions C_{V} are a same person may be determined through frequency band analysis. Further, the number of voice samples in the voice database 20 may be increased by storing the voice instruction C_{V}, so that the reference waveform can be further corrected, and whether the voice instruction C_{V} is abnormal can be more accurately determined.

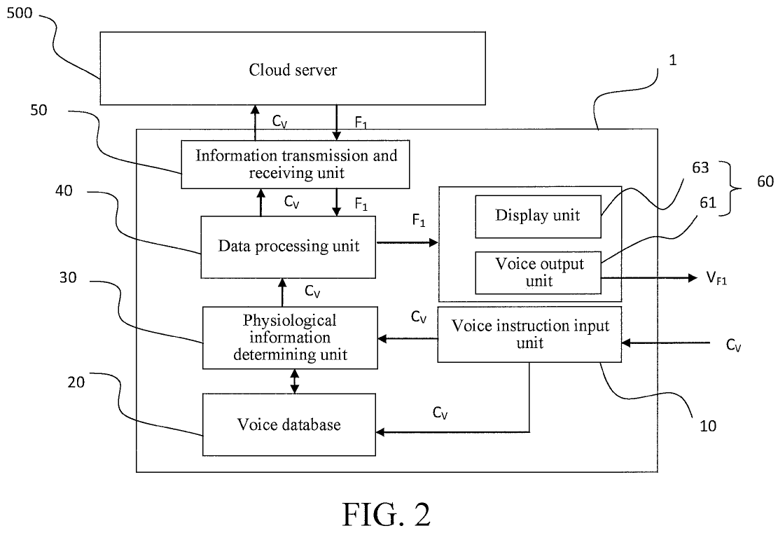

FIG. 2 is a schematic block diagram of an intelligent sound box 1 when a user is in a physiologically normal state. Referring to FIG. 1 and FIG. 2, the physiological information determining unit 30 does not generate a search instruction C_{S} when determining that a voice instruction C_{V} is normal, and the data processing unit 40 encodes and decodes the voice instruction C_{V} and the corresponded first feedback information F₁ that is received by the information transmission and receiving unit 50. The foregoing is merely an example.

For example, referring to FIG. 1 together, when a user sends to the intelligent sound box 1 with a voice instruction C_{V} “Good morning, will it rain today?”, the voice instruction input unit (for example, a microphone) 10 receives the voice instruction C_{V}. The physiological information determining unit 30 of the intelligent sound box 1 determines a waveform in the voice instruction C_{V} of the user and generates a search instruction C_{S} “What is the temperature a few days ago?” and “What is the time of the outpatient service of a hospital nearby?” when a deviation value between the waveform and a reference waveform exceeds a bottleneck value. The search instruction C_{S} is encoded by the data processing unit 40 and transmitted to the cloud server 500 by using the information transmission and receiving unit 50. After searching for related information, the cloud server 500 generates a first feedback information F₁, for example, “It will rain after 2:00 this afternoon, please bring an umbrella.”, that corresponds to the voice instruction C_{V}, and generates a second feedback information F₂, for example, “Your voice sounds strange. The weather a few days ago is relatively low, do you catch a cold?” and “The outpatient service of the hospital nearby starts at 9:00 in the morning.”, for the search instruction C_{S}, and outputs the first feedback information F₁ and the second feedback information F₂.

For another example, referring to FIG. 2 together, when the user sends to the intelligent sound box 1 with a voice instruction C_{V}, “Good morning, what is the temperature today?”, and the intelligent sound box 1 determines that a waveform in the voice instruction C_{V} of the user is normal, the voice instruction C_{V} is encoded by the data processing unit 40 and transmitted to the cloud server 500 by using the information transmission and receiving unit 50. After searching for related information, the cloud server 500 generates first feedback information F₁, for example, “The average temperature today is approximately 33 degrees, and the highest temperature reaches 36 degrees, please drink more water.”, that corresponds to the voice instruction C_{V}, and outputs the first feedback information F₁.

Further, in some embodiments, the feedback information output module 60 includes a voice output unit 61 configured to covert the first feedback information F₁ and the second feedback information F₂ into voice information V_{F1} and V_{F2} for playing. In other words, the intelligent sound box 1 has a VUI. Further, in some embodiments, the feedback information output module 60 further includes a display unit 63 configured to convert the first feedback information F₁ and the second feedback information F₂ into text information and/or image information for displaying. In other words, in these embodiments, the intelligent sound box 1 has a voice graphical hybrid user interface.

The data processing unit 40 is further electrically connected to the voice database 20. When the physiological information determining unit 30 determines that the voice instruction is abnormal, the data processing unit 40 adds a label to the voice instruction C_{V} and stores the voice instruction C_{VT} added with the label as a voice archive in the voice database 20. For example, when the physiological information determining unit 30 determines that the voice instruction C_{V} is abnormal, the data processing unit 40 may further add a label of “hoarse” or “catch a cold” to the voice instruction C_{VT}, and store the voice instruction C_{VT} in the voice database 20. In this way, if a similar case happens in the future, the physiological information determining unit 30 may perform determining based on the label, so that the overall determining whether the voice instruction C_{V} is normal or abnormal can be quicker and more accurate. The effect of machine learning algorithm of the intelligent sound box 1 is achieved by feeding and collecting massive voice instructions C_{V}. Further, the voice database 20 may be further disposed in the cloud server 500 to achieve a larger storage amount of the voice files.

Further, the data processing unit 40 may further modify the label of the voice instruction stored in the voice database 20 based on a subsequent voice instruction C_{V}. For example, the data processing unit 40 may further add the label “catch a cold” to the stored voice instruction C_{V}. When the feedback information output module 60 outputs the second feedback information F₂ “The voice sounds strange. The weather a few days ago is relatively low, do you catch a cold?”, if the user immediately generates a subsequent voice instruction “just stay up late”, it may be understood that the label “catch a cold” is incorrect, and the data processing unit 40 further modifies the label “catch a cold” in the voice instruction C_{VT} added with the label “catch a cold” into “stay up late” based on the subsequent voice instruction “just stay up late.”. Therefore, different waveforms can be more meticulously identified into different states, and the generated second feedback information F₂ can more accurately reflect a state of the user. In this way, not only a conventional problem that voice control cannot be performed due to a voice change, but also the user can feel intimate, thereby greatly improving the user experience.

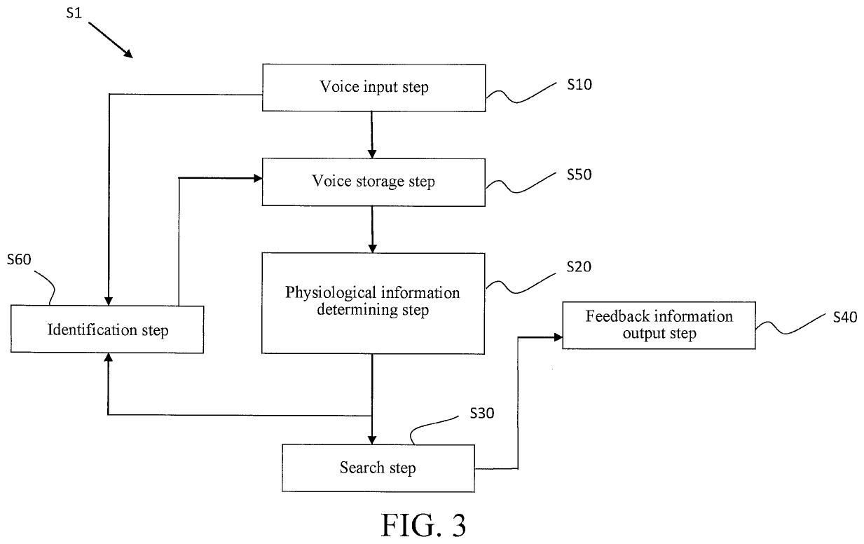

FIG. 3 is a flowchart of a method for providing a VUI particular response. As shown in FIG. 3, the method S1 for providing a VUI particular response includes a voice input step S10, a physiological information determining step S20, a search step S30, and a feedback information output step S40. Referring to FIG. 1 together, the voice input step S10 includes receiving a voice instruction C_{V}. The physiological information determining step S20 is accessing a voice archive in a voice database 20 and identifying whether the voice instruction C_{V} is abnormal, generating a search instruction C_{S} when determining that the voice instruction C_{V} is abnormal, and transmitting both the voice instruction C_{V} and the search instruction C_{S} out.

The search step S30 includes searching for a corresponding feedback based on the voice instruction C_{V} and the search instruction C_{S}, and respectively generating first feedback information F₁ and second feedback information F₂. The feedback information output step S40 includes outputting the first feedback information F₁ and the second feedback information F₂. The pre-stored voice files and the voice instruction C_{V} are determined by using voice, so that a problem that operations cannot be performed because a voice source cannot be identified can be resolved. In addition, the correlation of different voice instruction C_{V} can be obtained by using the search instruction C_{S}, or further assistance is provided. Therefore, the user can obtain better user experience.

Further, in some embodiments, the method S1 for providing a VUI particular response further includes a storage step S50 of storing the voice instruction C_{V} in a voice database 20. Determining of the different voice instruction C_{V} can be more accurate through sample accumulation of voice files. Further, machine learning algorithm can be completed based on learning through sample feeding, and the difference between various physiological states can be more meticulously distinguished between through the mutation of the voice. Although the storage step S50 is presented to be previous to the physiological information determining step S20 in FIG. 3 herein, this is merely an example, and the present invention is not limited thereto. The storage step S50 may be next to the voice input step S10 only, and there is no particular chronological order with other steps.

Further, in some embodiments, the method S1 for providing a VUI particular response further includes an identification step S60 of adding a label to the voice instruction C_{V} when determining that the voice instruction C_{V} is abnormal. Then the storage step S50 is performed: storing the voice instruction C_{VT} added with the label in the voice database 20. Further, in some embodiments, the label of the voice instruction stored in the voice database 20 may be further modified based on a subsequent voice instruction C_{V}. The voice archive can be further classified by adding the label, so that the correlation of generation of the search instruction C_{S} can be closer, thereby achieving better user interface experience of the user.

Based on this, when the voice instruction C_{V} is input, the intelligent sound box 1 can determine whether physiological information of the user is abnormal to perform a subsequent determining and feedback mechanism. The collection of voice samples and comparison with the voice instruction C_{V} may continuous improve the interaction with the user and resolve a problem of running termination due to difficulty of voice identification. The user can make a more real-time feedback or suggestion, so that the user has better user interface experience.

The technical solutions in the present invention have been described with reference to the preferred implementations shown in the accompanying drawings. However, a person skilled in the art easily understands that the protection scope of the present invention is not limited to these specific implementations. A person skilled in the art may make equivalent changes or replacements on related technical features without departing from the principle of the present invention. Technical solutions on which changes or replacements are performed all fall within the protection scope of the present invention.

What is claimed is:

1. A method for providing a voice user interface (VUI) particular response, comprising:
receiving a voice instruction;
identifying whether the voice instruction is abnormal;
generating a search instruction when determining that the voice instruction is abnormal;
transmitting the voice instruction and the search instruction;
searching for a corresponding feedback based on the voice instruction and the search instruction;
respectively generating first feedback information and second feedback information; and
outputting the first feedback information and the second feedback information.

2. The method according to claim 1, further comprising storing the voice instruction in a voice database.

3. The method according to claim 2, further comprising:
adding a label to the voice instruction if the voice instruction is abnormal; and
then storing the voice instruction added with the label in the voice database.

4. The method according to claim 3, further comprising modifying the label of the voice instruction stored in the voice database.

5. The method according to claim 1, further comprising comparing a reference waveform of the voice instruction with that of a voice archive to determine whether the voice instruction is abnormal.

6. An intelligent sound box, comprising:
a voice instruction input unit configured to receive a voice instruction and transmit the voice instruction;
a voice database electrically connected to the voice instruction input unit and configured to receive and store the voice instruction, wherein the voice database further stores a plurality of voice files;
a physiological information determining unit electrically connected to the voice instruction input unit and configured to:
receive the voice instruction;
identify whether the voice instruction is abnormal;
generate a search instruction when the physiological information determining unit determines that the voice instruction is abnormal; and
transmit the search instruction and the voice instruction;
a data processing unit electrically connected to the physiological information determining unit, and configured to:
receive the voice instruction and the search instruction;
encode the voice instruction and the search instruction; and
transmit the voice instruction and the search instruction;
an information transmission and receiving unit, electrically connected to the data processing unit, and configured to:
receive first feedback information and second feedback information that correspond to the voice instruction and the search instruction; and
transmit the first feedback information and the second feedback information to the data processing unit for decoding; and
a feedback information output module, electrically connected to the data processing unit and configured to:
receive the first feedback information and the second feedback information that are decoded by the data processing unit; and
output the first feedback information and the second feedback information.

7. The intelligent sound box according to claim 6, wherein the physiological information determining unit is configured to determine a waveform and compare a waveform of the voice instruction with that of a voice archive to determine whether the voice instruction is abnormal.

8. The intelligent sound box according to claim 6, wherein the information transmission and receiving unit is wirelessly connected to a cloud server, and the first feedback information and the second feedback information are correspondingly generated by the cloud server respectively based on the voice instruction and the search instruction that are encoded.

9. The intelligent sound box according to claim 6, wherein the feedback information output module comprises a voice output unit configured to convert the first feedback information and the second feedback information into voice information for playing.

10. The intelligent sound box according to claim 9, wherein the feedback information output module further comprises a display unit configured to convert the first feedback information and the second feedback information into text information or image information for displaying.
